(19) United States
(12) Patent Application Publication
(10) Pub. No.: US 2026/0149146 A1
(43) Pub. Date: May 28, 2026

(54) SECONDARY BATTERY

(71) Applicant: SAMSUNG SDI CO., LTD., Yongin-si (KR)

(72) Inventor: Kyungtae KIM, Yongin-si (KR)

(21) Appl. No.: 19/356,440

(22) Filed: Oct. 13, 2025

(30) Foreign Application Priority Data
Nov. 26, 2024 (KR) 10-2024-0171155

(51) Int. Cl. H01M 50/586; H01M 10/0587; H01M 50/107; H01M 50/109; H01M 50/152; H01M 50/153; H01M 50/167; H01M 50/186; H01M 50/533

(52) U.S. Cl. CPC H01M 50/586; H01M 10/0587; H01M 50/107; H01M 50/109; H01M 50/152; H01M 50/153; H01M 50/167; H01M 50/186; H01M 50/533

(57) ABSTRACT

A secondary battery includes an electrode assembly that includes electrode tabs, a case that accommodates the electrode assembly therein and includes an opening at one end, and a cap assembly sealing the opening in the case and electrically connected to the electrode tab. An insulating plate is positioned between the electrode assembly and the cap assembly in the case and includes a first opening and a plurality of second openings, with the first opening being formed to allow the electrode tab to extend therethrough toward the cap assembly, the plurality of second openings being formed around a center portion of the insulating plate. A horizontal cross-sectional area of at least one second opening of the plurality of second openings gradually decreases in a direction toward the electrode assembly.

### CROSS-REFERENCE TO RELATED APPLICATION

This present application claims priority to and the benefit under 35 U.S.C. § 119(a)-(d) of Korean Patent Application No. 10-2024-0171155, filed on Nov. 26, 2024, in the Korean Intellectual Property Office, the entire disclosure of which is incorporated herein by reference.

### BACKGROUND

### Technical Field

The present disclosure relates to a secondary battery.

### Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

A secondary battery includes an insulating plate provided between a cap assembly coupled to an opening of a case and an electrode assembly. The insulating plate may have an opening through which a lead tab or an electrode tab of the electrode assembly extending, an opening for injecting an electrolyte into the case, an opening for emitting gas generated from the electrode assembly to outside of the case, and the like. These openings may cause a short circuit between the electrodes of the electrode assembly and the cap assembly.

The above information disclosed in this Background section is for enhancement of understanding of the background of the present disclosure, and therefore, it may contain information that does not constitute related (or prior) art.

### SUMMARY

An object of the present disclosure is to provide a secondary battery for solving the above-described problems.

However, the technical problem to be solved by the present disclosure is not limited to the above problem, and other problems not mentioned herein, and aspects and features of the present disclosure that would address such problems, will be clearly understood by those skilled in the art from the description of the present disclosure below.

According to one or more embodiments of the present disclosure, a secondary battery includes an electrode assembly that includes electrode tabs, a case that accommodates the electrode assembly therein and includes an opening at one end, a cap assembly sealing the opening in the case and electrically connected to the electrode tab; and an insulating plate positioned between the electrode assembly and the cap assembly, the insulating plate including a first opening and a plurality of second openings, the first opening being formed to allow the electrode tab to extend therethrough toward the cap assembly, the plurality of second openings being formed around a center portion of the insulating plate, wherein a horizontal cross-sectional area of at least one second opening of the plurality of second openings may decrease in a direction toward the electrode assembly.

In an embodiment, the at least one second opening may have a tapered shape such that its horizontal cross-sectional area decreases in the direction toward the electrode assembly.

In an embodiment, a shape of a horizontal cross-section of the at least one second opening may be a circle, an ellipse, or a polygon.

In an embodiment, a shape of a horizontal cross-section of the at least one second opening may be a circle, and a diameter of a horizontal cross-section of a lowermost portion of the at least one second opening may be three to four times a total thickness of a first electrode and a second electrode of the electrode assembly.

In an embodiment, a diameter of a horizontal cross-section of an uppermost portion of the at least one second opening may be equal to or greater than twice the diameter of the horizontal cross-section of the lowermost portion of the second opening.

In an embodiment, the electrode assembly may be a wound-type electrode assembly, a shape of a horizontal cross-section of an uppermost portion of the at least one second opening may be a circle or an ellipse, and a shape of a horizontal cross-section of a lowermost portion of the at least one second opening may be a rectangle, and a long side of the rectangle may intersect a winding direction of the electrode assembly.

In an embodiment, a horizontal cross-section of the at least one second opening intersects a longitudinal direction of the electrode assembly.

In an embodiment, the insulating plate may be circular and may include a first semicircular region and a second semicircular region, the first opening may be located in the first semicircular region, and the at least one second opening may be located in the second semicircular region or across a boundary between the first semicircular region and the second semicircular region.

In an embodiment, a center of one side of the insulating plate may correspond to a center of a circle that passes through a center of the first opening and a center of each of the second openings.

In an embodiment, the electrode tab may be bent and pass over the second semicircular region, and an end of the electrode tab may be coupled to the cap assembly.

In an embodiment, the first opening and the second openings ate may be formed in the insulating plate by a die punching method.

In an embodiment, the insulating plate may include at least one of polypropylene (PP), polybutylene terephthalate (PBT), heat-resistant polystyrene (OPS), cross-linked polypropylene (PP), and cross-linked polyethylene (PE).

In an embodiment, a thickness of the insulating plate may be 0.3 mm to 0.5 mm.

In an embodiment, the insulating plate may further include a central opening at a center of the insulating plate.

In an embodiment, the electrode assembly may include a first electrode, a separator, and a second electrode, sequentially arranged in a wound structure, and a size of the second electrode may be greater than a size of the first electrode.

In an embodiment, the secondary battery may be a cylindrical, coin-type, or pin-type battery.

In an embodiment, the case may include a body portion having a cylindrical shape, and a beading portion protrudes inward from the body portion, and a crimping portion bent inward may be located at an open end of the body portion.

In an embodiment, the insulating plate may be positioned below the beading portion facing the electrode assembly.

In an embodiment, the secondary battery may further include a gasket that is positioned on an inner side of the crimping portion and presses an edge of the cap assembly.

According to one or more embodiments of the present disclosure, a secondary battery includes an electrode assembly that include an electrode tab, a case that accommodates the electrode assembly therein and includes an opening at one end, a cap assembly sealing the opening in the case and electrically connected to the electrode tab; and an insulating plate that is positioned between the electrode assembly and the cap assembly in the case, the insulating plate including a first opening and a plurality of second openings, the first opening being formed to allow the electrode tab to extend therethrough toward the cap assembly, the plurality of second openings being formed around a center portion of the insulating plate, wherein at least one second opening of the plurality of second openings may have a tapered shape such that a horizontal cross-sectional area of the second opening decreases in a direction toward the electrode assembly, the insulating plate may be circular and may include a first semicircular region and a second semicircular region, the first opening may be located in the first semicircular region, and the at least one second opening may be located in the second semicircular region or across a boundary between the first semicircular region and the second semicircular region.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to the present specification illustrate embodiments of the present disclosure and further describe aspects and features of the present disclosure together with the detailed description of the present disclosure. Thus, the present disclosure should not be construed as being limited to the drawings:

FIG. 1 is a perspective view of a secondary battery according to embodiments of the present disclosure.

FIG. 2 is a cross-sectional view of the secondary battery of FIG. 1 taken along a line AA′.

FIG. 3 is a diagram of an insulating plate according to embodiments of the present disclosure.

FIG. 4 is a cross-sectional view of the insulating plate taken along a line BB′ of FIG. 3.

FIG. 5 and FIG. 6 are top views of the insulating plate according to embodiments of the present disclosure.

FIG. 7 is a diagram of the upper surface of an insulating plate according to embodiments of the present disclosure.

FIG. 8 and FIG. 9 are diagrams for explaining a method of manufacturing an insulating plate according to embodiments of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terms used in the present specification are for the purpose of describing some embodiments of the present disclosure and are not intended to limit the present invention.

In the present disclosure, the sizes of layers and regions shown in the drawings indicate relative sizes and may be exaggerated for clarity of illustration. That is, the sizes shown in the drawings are only for convenience and are not limited thereto. Further, throughout the specification, the same reference numerals may designate the same elements.

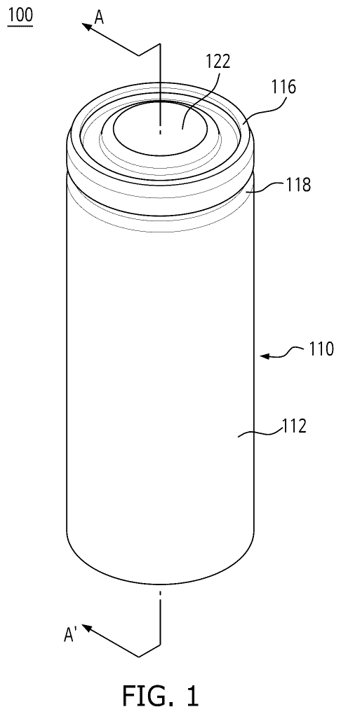

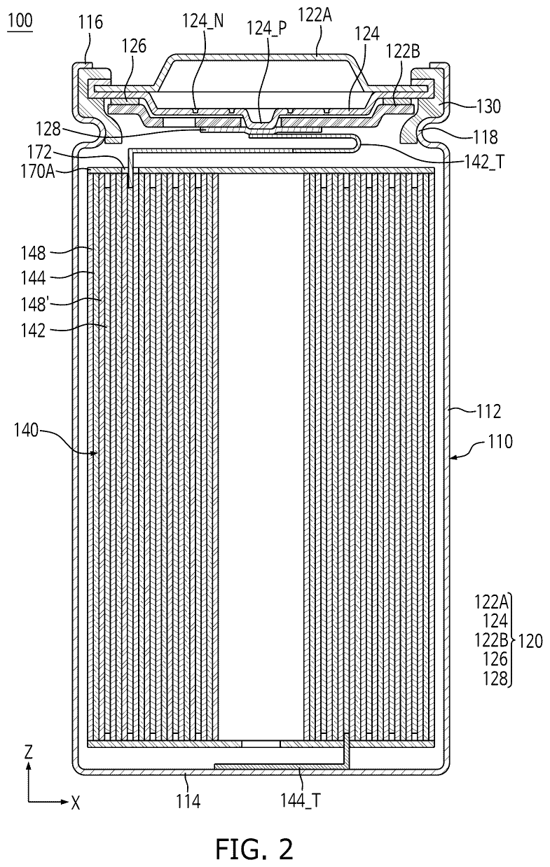

FIG. 1 is a perspective view of a secondary battery according to embodiments of the present disclosure. FIG. 2 is a cross-sectional view of the secondary battery of FIG. 1 taken along a line AA′. In the following description, a secondary battery having a cylindrical case will be described as an example. However, the secondary battery is not limited to such a configuration and may be a secondary battery having a coin shape, a pin shape, a prismatic shape, or the like.

Referring to FIG. 1 and FIG. 2, a secondary battery 100 according to embodiments may include an electrode assembly 140, a case 110 that accommodates an electrolyte (not illustrated) and the electrode assembly 140 therein, and a cap assembly 120 that is coupled to an opening of the case 110 to seal the case 110. An insulating plate 170A is provided between the electrode assembly 140 and the cap assembly 120 inside the case 110.

The electrode assembly 140 may include a first electrode 142, a second electrode 144, and a separator 148 interposed between the first electrode 142 and the second electrode 144. The electrode assembly 140 may be a wound-type electrode assembly formed by winding a first electrode 142, a second electrode 144, and a separator 148. In other embodiments, the electrode assembly 140 may be a stacked-type electrode assembly formed by repeatedly stacking a first electrode 142, a second electrode 144, and a separator 148. The example illustrated in FIG. 2 is a wound-type electrode assembly formed by winding the first electrode 142, the separator 148′, the second electrode 144, and the separator 148 that are stacked in this order.

The first electrode 142 may include a first substrate and a first active material layer disposed on the first substrate. A first electrode tab 142_T may extend outward from a first non-coating portion of the first substrate that does not include the first active material layer. The first electrode tab 142_T may be electrically connected to the cap assembly 120.

The second electrode 144 may include a second substrate and a second active material layer disposed on the second substrate. A second electrode tab 144_T may extend outward from a second non-coating portion of the second substrate that does not include the second active material layer. The second electrode tab 144_T may be electrically connected to the case 110. The first electrode tab 142_T and the second electrode tab 144_T may extend in opposite directions from the electrode assembly 140. The first electrode tab 142_T and the second electrode tab 144_T may be respectively bent at predetermined positions.

The first electrode 142 may function as a positive electrode. In some embodiments, the first substrate may be made of, for example, aluminum foil, and the first active material layer may include a positive electrode active material such as a transition metal oxide. The first active material layer may further include a conductive material and/or a binder. The second electrode 144 may function as a negative electrode. In some embodiments, the second substrate may be made of, for example, copper foil or nickel foil, and the second active material layer may include a negative electrode active material such as graphite. The second active material layer may further include a conductive material and/or a binder. In other embodiments, the first electrode may function as a negative electrode and the second electrode may function as a positive electrode.

The separators 148 and 148′ may function to allow movement of ions while preventing a short circuit between the first electrode 142 and the second electrode 144. The separators 148 and 148′ may be made of, for example, a polyethylene film, a polypropylene film, a polyethylene-polypropylene film, or the like.

Referring to FIG. 2, in the electrode assembly 140 according to some embodiments, the second electrode 144 may be larger than the first electrode 142. Further, sizes of the separators 148 and 148′ may be equal to or larger than a size of the second electrode 144. In some embodiments, a height (Z direction shown in FIG. 2) of the second electrode 144 may be greater than a height of the first electrode 142. Thus, the second electrode 144 may further protrude toward an upper side of the electrode assembly 140. And a distance between the second electrode 144 and the insulating plate 170A may be shorter than a distance between the first electrode 142 and the insulating plate 170A.

The electrolyte may be an electrolyte solution. The electrolyte solution may include lithium salt and an organic solvent. The lithium salt may include LiPF6, LiBF4, or the like, and the organic solvent may include ethylene carbonate (EC), propylene carbonate (PC), diethyl carbonate (DEC), dimethyl carbonate (DMC), ethyl methyl carbonate (EMC), or the like.

The case 110 may accommodate the electrode assembly 140 and the electrolyte therein. The case 110 forms an outer appearance of the secondary battery 100 together with the cap assembly 120. The case 110 may include a body portion 112 having a roughly cylindrical shape and a bottom portion 114 connected to one side of the body portion 112. A beading portion 118 that protrudes inward may be located at an upper part of the body portion 112. A crimping portion 116 that is inwardly bent may be located at an open end of the body portion 112.

The beading portion 118 may prevent the electrode assembly 140 from moving inside the case 110 and facilitate settling of a gasket 130 and the cap assembly 120. The crimping portion 116 may firmly fix the cap assembly 120 by pressing an edge of the cap assembly 120 via the gasket 130. The case 110 may be made of a metallic material, for example, iron plated with nickel.

The cap assembly 120 may be fixed to an inner side of the crimping portion 116 via the gasket 130 to seal the open end of the case 110. The cap assembly 120 may include an upper cap 122A, a vent portion 124, a lower cap 122B, an insulating member 126, and a sub-plate 128. Here, the cap assembly 120 is not limited to such a configuration. That is, the cap assembly 120 may have various configurations.

The upper cap 122A may be provided at the uppermost side of the cap assembly 120. The upper cap 122A may include a terminal portion that upwardly protrudes and is configured to be connected to an external circuit. A vent may be provided around the terminal portion of the cap up 122A to discharge gas.

The vent portion 124 may be provided below the cap upper 122A. The vent portion 124 may include a protrusion portion 124_P that is convex and protrudes downward and is connected to the sub-plate 128. At least one notch 124_N is formed around the protrusion portion 124_P. Gas may be generated inside the secondary battery 100 due to, for example, overcharging or an abnormal operation of the secondary battery 100. When the gas is generated, the protrusion portion 124_P may be upwardly deformed by the gas pressure and may be separated from the sub-plate 128. The vent portion 124 may hereby break along the notch 124_N. The gas is released to the outside via the cut vent portion 124, and thus, it is possible to prevent explosion or fire of the secondary battery 100.

The lower cap 122B may be provided below the vent portion 124. A first hole may be formed in the lower cap 122B corresponding to the protrusion portion 124_P of the vent portion 124 and a second hole may be formed in the lower cap 122B for discharging gas. The insulating member 126 may be provided between the vent portion 124 and the lower cap 122B to insulate between the vent portion 124 and the lower cap 122B.

The sub-plate 128 may be disposed below the lower cap 122B. The sub-plate 128 may be fixed to a lower surface of the cap down 122B to block the first hole of the lower cap 122B, and the protrusion portion 124_P of the vent portion 124 may be fixed to the sub-plate 128. The first electrode tab 142_T extending from the electrode assembly 140 may be fixed to the sub-plate 128. With this configuration, the upper cap 122A, the vent portion 124, the lower cap 122B, and the sub-plate 128 may be electrically connected to the first electrode 142 of the electrode assembly 140.

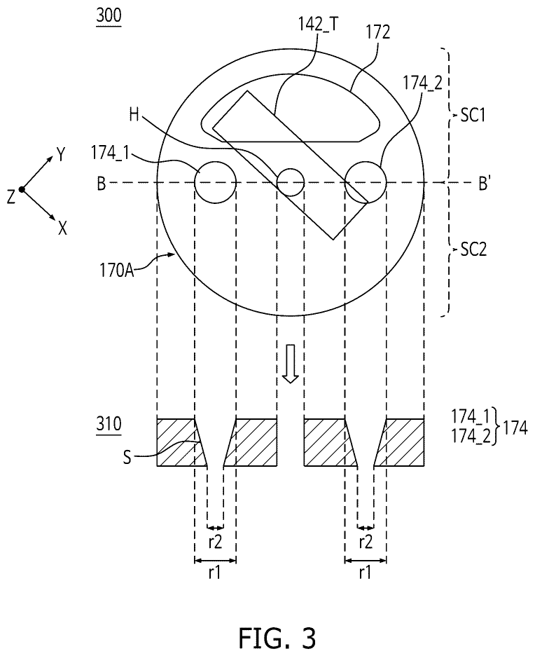

Referring to FIG. 2, the insulating plate 170A may be provided between the electrode assembly 140 and the cap assembly 120 inside the case 110. Further, the insulating plate 170A may be provided to face the electrode assembly 140 below the beading portion 118. The insulating plate 170A may be provided with a first opening 172 through which the first electrode tab 142_T extends in a direction toward the cap assembly 120. A plurality of second openings are formed around the center of the insulating plate 170A. Features of the first opening and the second openings will be described below with reference to FIG. 3 to FIG. 9.

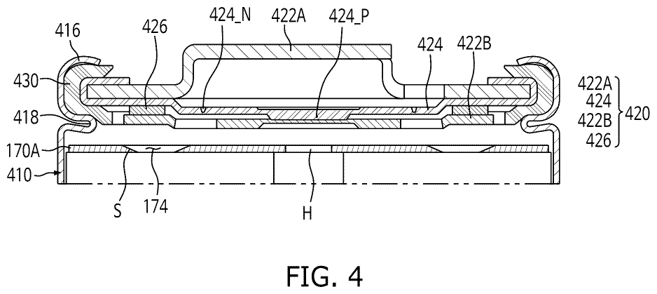

FIG. 2 illustrates a cross-section of the secondary battery 100 along an X-Z plane. In the insulating plate 170A of FIG. 2, only the first opening 172 through which the electrode tab 142_T extends is illustrated. FIG. 3 and FIG. 4 illustrate cross-sections of a portion of the insulating plate 170A where the second openings 174 are formed cross-sections of the second openings 174.

The cap assembly 120, which is electrically connected to the first electrode 142 by the first electrode tab 142_T, may face the electrode assembly 140. The insulating plate 170A may be positioned between the cap assembly 120 and the electrode assembly 140 to maintain an insulated state between the cap assembly 120 and the electrode assembly 140.

The insulating plate 170A may be formed from at least one of polypropylene (PP), polybutylene terephthalate (PBT), heat-resistant polystyrene (OPS), cross-linked polypropylene (PP), or cross-linked polyethylene (PE). In addition to these materials, in other embodiments any insulating material that can have an opening formed by a die punching method may be used as a material for the insulating plate 170A.

A thickness of the insulating plate 170A according to some embodiments may be approximately 0.3 mm to 0.5 mm. When the insulating plate 170A is thinner than 0.3 mm, the insulating function of the insulating plate 170A may be too little, and, thus, a short circuit between the cap assembly 120 and the electrode assembly 140 may occur. When the insulating plate 170A is thicker than 0.5 mm, the insulating plate 170A may occupy an excessive volume inside the case 110, and, thus, a capacity of the secondary battery 100 may be reduced.

FIG. 3 is a diagram illustrating the insulating plate according to some embodiments of the present disclosure. FIG. 4 illustrates a portion of a cross-section of the insulating plate taken along a line BB′ of FIG. 3. In particular, FIG. 3 and FIG. 4 illustrate an upper surface and a cross section of the insulating plate 170A described above with reference to FIG. 2.

Referring to a top view 300 of the insulating plate in FIG. 3, the insulating plate 170A according to some embodiments have the first opening 172 formed therethrough, with the electrode tab 142_T extending through the first opening 172. The plurality of second openings 174 are formed around the center of the insulating plate 170A. The insulating plate 170A may be formed in a circle shape including a first semicircular region SC1 and a second semicircular region SC2. But the insulating plate may be formed in various other shapes depending on the shape of the case of the secondary battery. For example, when a secondary battery has a prismatic shape, the insulating plate 170A may be formed in a square shape including a first square region and a second square region.

The first opening 172 may be sized to allow the first electrode tab 142_T to pass through and may be formed in the first semicircular region SC1. Further, the first opening 172 may form a passage through which gas generated in the electrode assembly (for example, 140 in FIG. 2) is discharged to outside of the battery. In particular, in the first opening 172 gas may pass through an empty space other part occupied by the first electrode tab 142_T.

Referring to the top view 300 of the insulating plate in FIG. 3, in some embodiments, a central hole H at the center of the insulating plate 170A may be formed at the center portion of the insulating plate 170A, and the plurality of second openings 174 may be formed around the center portion of the insulating plate 170A. The central hole H may be provided at the winding center of the electrode assembly (for example, 140 in FIG. 2).

The plurality of second openings 174 may be passages through which gas generated by the electrode assembly is discharged and/or openings through which the electrolyte is injected into the case 110. The second openings 174 may be formed in the second semicircular region SC2 or across a boundary between the first semicircular region SC1 and the second semicircular region SC2. In FIG. 3, the second openings are formed across the boundary between the first semicircular region SC1 and the second semicircular region SC2.

Referring to a longitudinal cross-sectional view 310 of the insulating plate in FIG. 3, a horizontal cross-sectional area of at least one of the plurality of second openings 174 formed on the insulating plate 170A may gradually decrease in a direction toward the electrode assembly (a negative Z direction). For example, at least one of second openings 174 may have a tapered shape such that the horizontal cross-sectional area gradually decreases in the direction toward the electrode assembly (the negative Z direction).

Referring to the top view 300 of the insulating plate in FIG. 3, the second openings 174 which are included in the plurality of second openings 174 and have decreasing horizontal cross-sectional areas in the direction toward the electrode assembly may be formed in the second semicircular region or across the boundary between the first semicircular region and the second semicircular region. The shape of the second openings 172 may be such that gas is not easily discharged through the second openings 172. For this reason, the number of the second openings 172 may be more than two.

Referring to FIG. 2, in the electrode assembly 140 according to some embodiments, the height (in the Z direction) of the second electrode 144 is greater than the height of the first electrode 142. Thus, the second electrode 144 may further protrude toward the upper side of the electrode assembly 140. As such, a distance between an upper end of the second electrode 144 and the insulating plate 170A may be shorter than a distance between an upper end of the first electrode 142 and the insulating plate 170A. During the charging and discharging process of the secondary battery, the first electrode 142 and the second electrode 144 of the electrode assembly 140 may expand and contract. As the charging and discharging process of the secondary battery 100 is performed several times, the electrode at a portion at which higher pressure is applied may have a higher expansion rate.

When the horizontal cross-sectional area of the second opening 174 is constant and the second electrode of the electrode assembly is provided below the second opening 174 of the insulating plate, the second electrode expand through the second opening 174. For example, one end of the second electrode may be bent and pass through the second opening 174. In such a case, a short circuit may occur when a portion of the second electrode that has passed through the second opening 174 of the insulating plate comes into contact with the first electrode tab 142_T that extends from the first semicircular region SC1 and is bent toward an upper side of the second semicircular region SC2. But, as described above, the second opening 174 according to some embodiments of the present disclosure may have a horizontal cross-sectional area that gradually decreases in the direction toward the electrode assembly (the negative Z direction). Thus, the second electrode is less likely to pass through the second opening 174. That is, because a horizontal cross-sectional area of a lowest portion of the second opening 174 is small, a portion of the second electrode is unlikely to pass through the lowest portion of the second opening 174 during charging and discharging. Even in a case where a portion of the second electrode does pass through the horizontal cross-section of the lowermost portion of the second opening 174, in the insulating plate 170A, the portion of the second electrode may be blocked by an inclined surface S of the second opening 174, and, thus, the portion of the second electrode may not easily pass through the second opening 174.

As illustrated in FIG. 2 and FIG. 3, the first electrode tab 142_T may pass through the first opening 172 in the first semicircular region SC1, may extend toward the upper side of the second semicircular region SC2, may be bent, may extend in a direction toward the cap assembly, and then may be connected to a lower end of the cap assembly 120. As discussed above, when the horizontal cross-sectional area of the second opening 174 is constant, a portion of the second electrode may pass through the second opening 174 and may come into contact with the first electrode tab 142_T. But, as also described above, the second opening 174 according to embodiments of the present disclosure may have a horizontal cross sectional area that gradually decreases in the direction toward the electrode assembly (the negative Z direction). Thus, the second electrode is unlikely to pass through the second opening 174 and there is a reduced a risk of a short circuit.

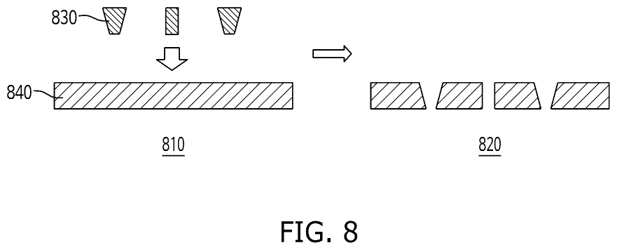

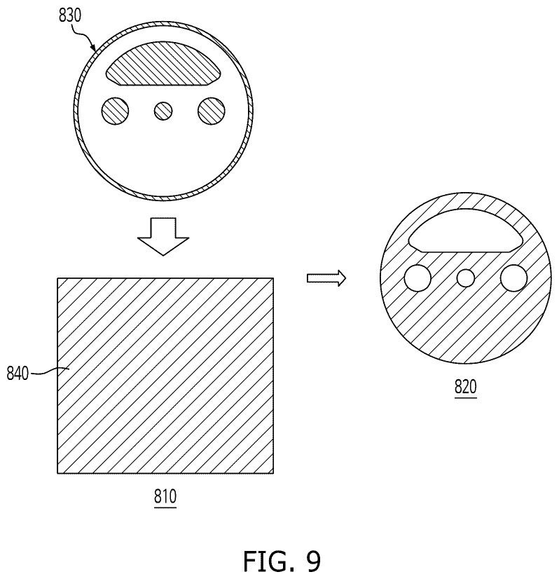

In some embodiments, a diameter r2 of the lowermost portion of the second opening 174 may be three to four times the total thickness of the first electrode and the second electrode of the electrode assembly. When the diameter r2 of the lowermost portion of the second opening 174 is less than three times the total thickness of the first electrode and the second electrode, it may be difficult to smoothly discharge gas generated from the electrode assembly. When the gas is not smoothly discharged, there is a danger of a fire or explosion in the secondary battery. Further, when the diameter r2 of the horizontal cross-section of the lowermost portion of the second opening 174 is less than three times the total thickness of the first electrode and the second electrode, it may be difficult to manufacture a secondary battery by using a die punching method, which will be described below with reference to FIG. 8 and FIG. 9.

In a case where the diameter r2 of the lowermost portion of the second opening 174 is greater than four times the total thickness of the first electrode and the second electrode, the second electrode may easily pass through the cross-section of the lowest portion of the second opening 174 in a case where the second electrode expands. Further, in a case where the diameter r2 of the lowermost portion of the second opening 174 is greater than four times the total thickness of the first electrode and the second electrode, one end of the first electrode tab 142_T may extend through the second opening 174.

In some embodiments, a diameter r1 of an uppermost portion of the second opening 174 may be equal to or greater than twice the diameter r2 of the lowermost portion of the second opening 174. When the diameter r1 of the uppermost portion of the second opening 174 is less than twice the diameter r2 of the lowermost portion of the second opening 174, gas generated from the electrode assembly may not be smoothly discharged.

In some embodiments, the central hole H may a different horizontal cross-sectional shape than the second opening 174 as described above. This may be because when the electrode assembly is a winding-type electrode assembly and the center of the winding shaft is located below the central hole H, the above-described problem of a short circuit due to expansion of the second electrode does not occur.

FIG. 4 is a diagram illustrating a portion of the cross-section of the secondary battery in which the first insulating plate 170A described above is provided between the cap assembly 420 and the electrode assembly. In FIG. 4, illustration of the first electrode tab is omitted for convenience.

Referring to FIG. 4, the cap assembly 420 according to some embodiments may be fixed to the inner side of the crimping portion 416 via the gasket 430 to seal the open end of the case 410. The cap assembly 420 may include the upper cap 422A, the vent portion 424, the lower cap 422B, and the insulating member 426. Unlike the cap assembly 120 described above with reference to FIG. 2, the cap assembly 420 may not include the sub-plate 128.

The upper cap 422A, the vent portion 424, the lower cap 422B, the insulating member 426, the crimping portion 416, the beading portion 418, and the gasket 430 illustrated in FIG. 4 may be substantially identical to the corresponding components described above with reference to FIG. 2. In some embodiments, a lower end of the lower cap 422B may be upwardly recessed to provide a space in which the first electrode tab is fixed. The protrusion portion 424_P of the vent portion 424 may pass through an opening formed at the center of the lower cap 422B.

In some embodiments, the second opening(s) 174 formed on the insulating plate 170A may be provided below a portion of the lower cap 422B that is in contact with the insulating member 426. With this arrangement, it is possible to efficiently discharge gas generated at an edge of the electrode assembly where the amount of the generated gas is greater than the amount of gas generated at the winding center of the electrode assembly.

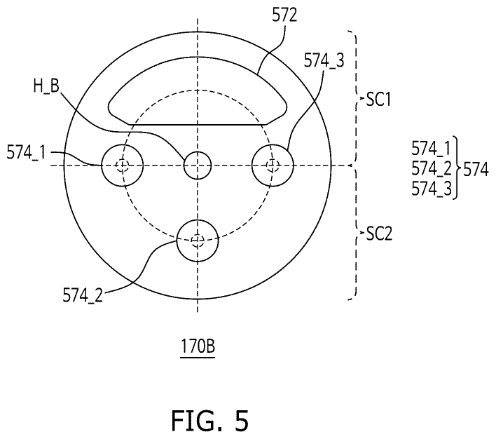

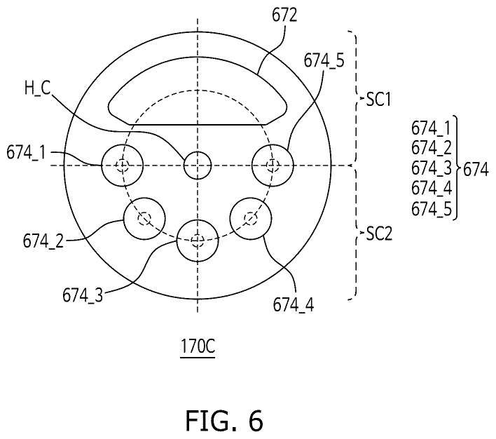

FIG. 5 and FIG. 6 are top views of the insulating plate according to embodiments of the present disclosure. In the following description, the upper surface of the insulating plate will be described in detail. Descriptions that are the same as those above may be omitted, and in the embodiments depicted in FIG. 5 and FIG. 6 the second openings have the horizontal cross-sectional shapes described above. In FIG. 5 and FIG. 6, dotted circles illustrated in the second openings indicate a boundary of a lower cross-section of each of the second openings.

In some embodiments, the shape of the horizontal cross-section of at least one of the second openings 574 may be a circle or an ellipse. In some embodiments, the horizontal cross-section of at least one of the second openings 574 be a circle shape, and the horizontal cross-section gradually decreases in the direction toward the electrode assembly, that is, the winding direction of the electrode assembly. The horizontal cross-section of the lower portions of the second openings 574 is illustrated by the dotted circle in FIG. 5 and FIG. 6.

Referring to FIG. 5 and FIG. 6, in some embodiments, the center of one side of the insulating plate 170B or 170C may correspond to the center of an imaginary circle that passes through the center of the first opening 572 or 672 and the center of each of the second openings 574 and 674.

Referring to FIG. 5, the horizontal cross-section of each of the second openings 574 formed on the insulating plate 170B according to some embodiments may intersect the longitudinal direction of the electrode assembly, that is, the winding direction of the electrode assembly, which is illustrated as the dotted circle in FIG. 5. For example, the horizontal cross-section of each of the second openings 574 may be orthogonal to the winding direction of the electrode assembly. The second electrode may significantly expand in its thickness direction. Thus, with this arrangement as described above, it is possible to reduce a risk that the second electrode expands through the second openings 574.

Three of the second openings 574 may be formed at the above-described positions in the insulating plate 170B as illustrated in FIG. 5, or in five of the openings 674 may be formed in the insulating plate 170C as illustrated in FIG. 6. Further, a central hole H_B or H_C may be formed at the center of the insulating plate 170B or 170C.

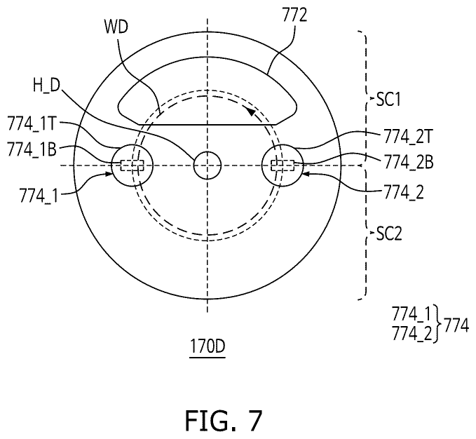

FIG. 7 illustrates the upper surface of the insulating plate according to some embodiments of the present disclosure.

A horizontal cross-section of at least one of the plurality of second openings 774 in the insulating plate 170D may be a polygon shape. For example, as illustrated in FIG. 7, the shapes of the horizontal cross-sections of lowermost portions 774_1B and 774_2B may be rectangular. FIG. 7 illustrates an embodiment where the insulating plate 170D the horizontal cross-sectional areas of the second openings 774 gradually decrease in the direction toward the electrode assembly.

The shapes of the horizontal cross-sections of the uppermost portions 774_1T and 774_2T of the plurality of second openings 774_1 and 774_2 may be a circle or an ellipse. The shapes of the horizontal cross-sections of the lowermost portions 774_1B and 774_2B of the second openings 774_1 and 774_2 may be rectangular, and a long side of the rectangle may correspond to the winding direction WD of the electrode assembly. For example, as illustrated in FIG. 7, the shapes of the horizontal cross-sections of the uppermost portions 774_1T and 774_2T of the second openings 774_1 and 774_2 may be circular. The shapes of the horizontal cross-sections of the lowermost portions 774_1B and 774_2B of the second openings 774_1 and 774_2 may be a rectangular, and a long side of the rectangle shape may correspond to the winding direction WD of the electrode assembly. With this arrangement, even if the second electrode expands in its thickness direction, the second electrode is unlikely to pass through the cross sections of the lowermost portions 774_1B and 774_2B of the second openings 774_1 and 774_2.

Referring to FIG. 7, in some embodiments, the horizontal cross sectional areas of the second openings 774_1 and 774_2 may gradually decrease in the direction toward the electrode assembly. The horizontal cross-sections of the second openings 774_1 and 774_2 may be orthogonal to the longitudinal direction of the electrode assembly, that is, the winding direction WD of the electrode assembly.

The above-described second openings 774_1 and 774_2 may be formed in the second semicircular region SC2 or across the boundary between the first semicircular region SC1 and the second semicircular region SC2. Further, the center of a side of the insulating plate 170D may correspond to the center of a circle (illustrated as a dotted circle in FIG. 7) that passes through the center of the first opening 772 and the center of each of the second openings 774_1 and 774_2.

FIG. 8 and FIG. 9 are diagrams for explaining a method of manufacturing the insulating plate according to embodiments of the present disclosure. FIG. 8 illustrates a manufacturing process at the longitudinal section of the insulating plate, and FIG. 9 illustrates a manufacturing process at the upper surface of the insulating plate.

In some embodiments, the first opening and the plurality of second openings of the insulating plate may be formed by a die punching method. But the formation method is not limited thereto. For example, in other embodiments, the first opening and the plurality of second openings of the insulating plate may be formed by injection molding or extrusion molding.

Referring to FIG. 8, in order to manufacture the insulating plate described above in FIG. 3, a punch mold 830 may be prepared by placing a mold having a rectangular cross-section on a portion that will become the central hole and placing molds having trapezoidal cross-sections on both sides of the mold to form the second openings that have inclined surfaces such that the horizontal cross-sectional areas gradually decreases in the direction toward the electrode assembly. By lowering the punch mold 830 toward a sheet 840 and pressing the mold 830 (810), the insulating plate having the first opening, the second openings, and the central hole may be manufactured (820).

Referring to FIG. 9, the punch mold 830 for forming the first opening, the plurality of second openings, the central hole, and the boundary of the insulating plate may be prepared to manufacture the insulating plate described with reference to FIG. 3. When the sheet 840 made of the insulating material described above is die-punched by using the punch mold 830 (810), an insulating plate having the upper surface with the shape described in FIG. 3 may be manufactured (820).

According to the present disclosure, it is possible to improve efficiency when manufacturing an insulating plate having openings that an inclined surfaces such that the horizontal cross-sectional areas of the openings gradually decrease in the direction toward the electrode assembly.

Although the present disclosure has been described above with respect to embodiments thereof, the present disclosure is not limited thereto. Various modifications and variations can be made thereto by those skilled in the art within the spirit of the present disclosure.

What is claimed is:

1. A secondary battery comprising:
an electrode assembly including an electrode tab;
a case that accommodates the electrode assembly therein and includes an opening at one end;
a cap assembly sealing the opening in the case and electrically connected to the electrode tab; and
an insulating plate positioned between the electrode assembly and the cap assembly in the case, the insulating plate including a first opening and a plurality of second openings, the first opening being formed to allow the electrode tab to extend therethrough toward the cap assembly, the plurality of second openings being formed around a center portion of the insulating plate,
wherein a horizontal cross-sectional area of at least one second opening of the plurality of second openings decreases in a direction toward the electrode assembly.

2. The secondary battery as claimed in claim 1, wherein the at least one second opening has a tapered shape such that its horizontal cross-sectional area decreases in the direction toward the electrode assembly.

3. The secondary battery as claimed in claim 1, wherein a shape of a horizontal cross-section of the at least one second opening is a circle, an ellipse, or a polygon.

4. The secondary battery as claimed in claim 1, wherein a shape of a horizontal cross-section of the at least one second opening is a circle, and
wherein a diameter of a horizontal cross-section of a lowermost portion of the at least one second opening is three to four times a total thickness of a first electrode and a second electrode of the electrode assembly.

5. The secondary battery as claimed in claim 4, wherein a diameter of a horizontal cross-section of an uppermost portion of the at least one second opening is equal to or greater than twice the diameter of the horizontal cross-section of the lowermost portion of the second opening.

6. The secondary battery as claimed in claim 1, wherein the electrode assembly is a wound-type electrode assembly,
wherein a shape of a horizontal cross-section of an uppermost portion of the at least one second opening is a circle or an ellipse, and a shape of a horizontal cross-section of a lowermost portion of the at least one second opening is a rectangle, and
wherein a long side of the rectangle intersects a winding direction of the electrode assembly.

7. The secondary battery as claimed in claim 1, wherein a horizontal cross-section of the at least one second opening among the plurality of second openings, and of which the horizontal cross sectional area gradually decreases in the direction toward the electrode assembly intersects a longitudinal direction of the electrode assembly.

8. The secondary battery as claimed in claim 1, wherein the insulating plate is circular and includes a first semicircular region and a second semicircular region,
wherein the first opening is located in the first semicircular region, and
wherein the at least one second opening is located in the second semicircular region or across a boundary between the first semicircular region and the second semicircular region.

9. The secondary battery as claimed in claim 8, wherein a center of a side of the insulating plate corresponds to a center of a circle that passes through a center of the first opening and a center of each of the second openings.

10. The secondary battery as claimed in claim 8, wherein the electrode tabis bent and passes over the second semicircular region, and an end of the electrode tab is coupled to the cap assembly.

11. The secondary battery as claimed in claim 1, wherein the first opening and the second openings are formed in the insulating plate by a die punching method.

12. The secondary battery as claimed in claim 1, wherein the insulating plate comprises at least one of polypropylene (PP), polybutylene terephthalate (PBT), heat-resistant polystyrene (OPS), cross-linked polypropylene (PP), and cross-linked polyethylene (PE).

13. The secondary battery as claimed in claim 1, wherein a thickness of the insulating plate is 0.3 mm to 0.5 mm.

14. The secondary battery as claimed in claim 1, wherein the insulating plate further comprises a central opening at a center of the insulating plate.

15. The secondary battery as claimed in claim 1, wherein the electrode assembly comprises a first electrode, a separator, and a second electrode sequentially arranged in a wound structure, and
wherein a size of the second electrode is greater than a size of the first electrode.

16. The secondary battery as claimed in claim 1, wherein the secondary battery is a cylindrical, coin-type, or pin-type battery.

17. The secondary battery as claimed in claim 1, wherein the case comprises a body portion having a cylindrical shape, and
wherein a beading portion protrudes inward from the body portion and a crimping portion bent inward is located at an open end of the body portion.

18. The secondary battery as claimed in claim 17, wherein the insulating plate is positioned below the beading portion and faces the electrode assembly.

19. The secondary battery as claimed in claim 17, further comprising:
a gasket that is positioned on an inner side of the crimping portion and presses an edge of the cap assembly.

20. A secondary battery comprising:
an electrode assembly that includes an electrode tab;
a case that accommodates the electrode assembly therein and includes an opening at one end;
a cap assembly sealing the opening in the case and electrically connected to the electrode tab; and
an insulating plate positioned between the electrode assembly and the cap assembly in the case, the insulating plate including a first opening and a plurality of second openings, the first opening being formed to allow the electrode tab to extend therethrough toward the cap assembly, the plurality of second openings being formed around a center portion of the insulating plate,
wherein at least one second opening of the plurality of second openings has a tapered shape such that a horizontal cross-sectional area of the second opening decreases in a direction toward the electrode assembly,
wherein the insulating plate is circular and includes a first semicircular region and a second semicircular region,
wherein the first opening is located in the first semicircular region, and
wherein the at least one second opening is located in the second semicircular region or across a boundary between the first semicircular region and the second semicircular region.
